(19) United States
(12) Patent Application Publication
(10) Pub. No.: US 2005/0190033 A1
(43) Pub. Date: Sep. 1, 2005

(54) Solenoid

(76) Inventors: Arndt Heinemann, Neustadt (DE); Werner Leuschner, Hannover (DE)

Correspondence Address: MURAMATSU & ASSOCIATES, Suite 225, 7700 Irvine Center Drive, Irvine, CA, 92618, US

(21) Appl. No.: 10/997,549

(22) Filed: Nov. 24, 2004

(30) Foreign Application Priority Data
Feb. 27, 2004 (DE) 10 2004 009 690.2

(51) Int. Cl. H01F 27/02

(52) U.S. Cl. 336/196

(57) ABSTRACT

A solenoid for use as a magnet coil has an outer casing of plastics material, a plurality of ribs being provided on the outside of the casing as protection against impact. The material and costs of the magnetic coil can be saved while ensuring sufficient impact resistance.

### FIELD OF THE INVENTION

The invention relates to a solenoid having an outer casing of plastics material for use as a magnet coil.

### BACKGROUND OF THE INVENTION

Magnet coils (solenoids) for hazardous areas have to satisfy an impact test according to the Standards EN 50 014 and EN 50 028. In this test the areas exposed to impact are hit vertically with a hemispherical test piece.

Special measures must be taken in order to satisfy this regulation, especially in the case of low temperatures (for example −50° C.) , because the casing must not have any cracks and the internal electrical components, especially the winding, have to be protected.

In order to ensure sufficient impact resistance, the plastics casing is usually reinforced accordingly. However, additional material is required for the purpose, which gives rise to higher costs.

### SUMMARY OF THE INVENTION

The object of the invention is therefore to improve the magnet coil having an outer casing of plastics material to the effect that material and costs can be saved in ensuring sufficient impact resistance.

That object is achieved according to the invention by the features defined in the appended claims.

The coil according to the invention is distinguished by the fact that the outer casing of plastics material has a plurality of ribs on the outside as protection against impact. The ribs can absorb energy by deformation like a crumple zone so that the casing itself is protected against relatively great impact energy.

The arrangement and the form of the ribs are such that the test piece defined in the Standards can hit the ribs but not the actual casing face.

Further forms of the invention are the subject matter of the subordinate claims.

According to a preferred embodiment, the casing and the ribs are manufactured from injection molded plastics material. The ribs are advantageously arranged parallel with one another and form fins whose width is smaller than their height.

Further forms and advantages of the invention are explained in more detail hereinafter by means of the description of an embodiment and the drawings.

### BRIEF DESCRIPTION OF THE INVENTION

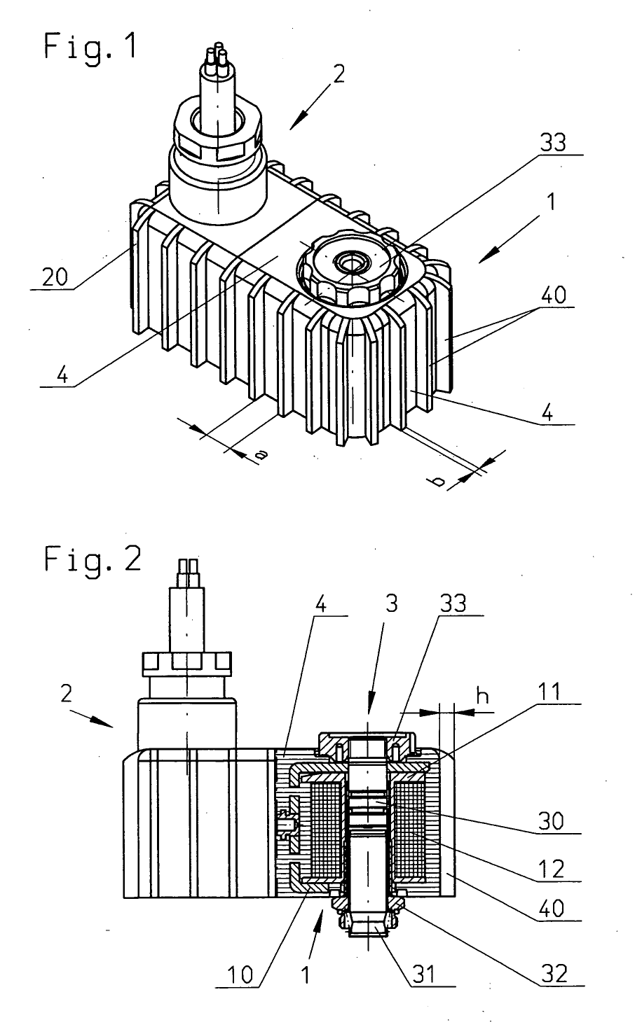

FIG. 1 is a three-dimensional representation of a magnet coil according to the invention with an electrical connector housing.

FIG. 2 is a partly sectioned side view of the magnet coil with a connector housing according to FIG. 1.

### DETAILED DESCRIPTION OF THE INVENTION

FIG. 1 shows a magnet coil (solenoid) 1 and an electrical connector housing 2 which are connected securely to each other. The coil 1 shown in more detail in FIG. 2 substantially comprises a yoke 10, a coil body 11 and a coil winding 12. Also shown are the components of an armature system 3 which, in detail, comprises a magnet core 30, an armature 31, an armature guide 32 and a securing nut 33.

The magnet coil 1 also has an outer casing 4 of plastics material which is normally manufactured by an injection molding process. A plurality of ribs 40 are also provided on the outside of the casing 4 as protection against impact.

In the embodiment shown, the ribs are formed by fins whose width b is smaller than their height h. The ratio of the distance a to the height h of the ribs is preferably in the range of from 1 to 2.

Within the scope of the invention, other configurations of the ribs are of course also possible. The form of the ribs is advantageously selected in such a manner that, on the one hand, as little material as possible is required, and, on the other hand, the criteria of the impact test are met in accordance with the Standards to be observed.

The ribs 40 are expediently composed of the same material as the casing 4, it being possible for the casing and the ribs to be manufactured simultaneously by an injection molding process.

In the embodiment shown, the ribs 40 are provided only on the side faces of the magnet coil 1 because, by definition, the impact can come only from above and from the side. The upper region, in which the securing nut 33 is in this case provided, has dimensions such that the test piece cannot cause any damage to the casing 4. Accordingly, no ribs are provided here. However, within the scope of the invention, this region may also have ribs if necessary or expedient.

The connector housing 2 manufactured separately from the coil 1 is connected securely to the coil 1, for example by adhesive bonding, screwing or casting. The connector housing 2 likewise has on its outer circumferential face ribs 20 which correspond in terms of their form to the ribs 40 of the magnet coil 1.

The ribs 40 and 20 protect the component formed by the magnet coil 1 and the connector housing 2, respectively, to a sufficient extent against impact, and it is possible to save material and costs for the casing compared with conventional designs.

1. A magnet coil (1) having an outer casing (4) of plastics material, characterized in that the casing has a plurality of ribs (40) on the outside as protection against impact.

2. A magnet coil according to claim 1, characterized in that the ribs (40) are arranged parallel with each other.

3. A magnet coil according to claim 1, characterized in that the ribs (40) are formed by fins whose width (b) is smaller than their height (h).

4. A magnet coil according to claim 1, characterized in that the ratio of the distance (a) to the height (h) of the ribs (40) is in the range of from 1 to 2.

5. A magnet coil according to claim 1, characterized in that the casing (4) and the ribs (40) are manufactured from the same material.

6. A magnet coil according to claim 1, characterized in that the casing (4) and the ribs (40) are manufactured from injection-molded plastics material.

7. A magnet coil according to claim 1, characterized in that the ribs (4) are provided on side faces of the magnet coil (1).

8. A magnet coil according to claim 1, characterized in that the magnet coil (1) is provided with an electrical connector housing (2) which likewise has ribs (20).

9. A magnet coil according to claim 1, characterized in that the magnet coil (1) is provided with an electrical connector housing (2), the magnet coil and the connector housing being connected securely to each other by casting, screwing or adhesive bonding.
